(19) United States
(12) Patent Application Publication
(10) Pub. No.: US 2026/0084138 A1
(43) Pub. Date: Mar. 26, 2026

(54) Catalyst Structure And Method For Producing Catalyst Structure

(71) Applicant: SEIKO EPSON CORPORATION, Tokyo (JP)

(72) Inventor: Kengo HONMA, Chino (JP)

(21) Appl. No.: 19/339,821

(22) Filed: Sep. 25, 2025

(30) Foreign Application Priority Data
Sep. 26, 2024 (JP) 2024-167936

(51) Int. Cl. B01J 23/72; B01J 23/42; B01J 23/62; B01J 37/02; B01J 37/12

(52) U.S. Cl. CPC B01J 23/72; B01J 23/42; B01J 23/62; B01J 37/0225; B01J 37/12

(57) ABSTRACT

Provided is a catalyst structure, which is for use in a reforming reaction for reforming a raw material and which has a particle shape, and the catalyst structure includes: a core particle containing a first metal element and having a particle shape; a coating film containing a second metal element and covering a surface of the core particle; and a plurality of oxide particles each containing an oxide of the first metal element and adhering to a surface of the coating film, in which both the coating film and the oxide particles are exposed.

The present application is based on, and claims priority from JP Application Serial Number 2024-167936, filed Sep. 26, 2024, the disclosure of which is hereby incorporated by reference herein in its entirety.

### BACKGROUND

### 1. Technical Field

The present disclosure relates to a catalyst structure and a method for producing the catalyst structure.

### 2. Related Art

In a reforming reaction for reforming raw materials to obtain a reformed material, a catalyst for improving reaction efficiency is used. The catalyst has a carrier and an active substance supported thereon. As a method for improving the reaction efficiency of the reforming reaction, there is a method for increasing contact efficiency between the raw materials and a catalyst active point by increasing a specific surface area of the catalyst.

For example, JP-A-2019-136702 discloses a zeolite catalyst used for reforming raw materials. The zeolite catalyst contains a mixture of zeolite and a compound containing an alkaline earth metal and silicon, and has a particle shape. JP-A-2019-136702 is an example of the related art.

JP-A-2019-136702 also discloses that the zeolite catalyst is produced through a step of forming the mixture of the powdery zeolite and the compound and firing the mixture. Therefore, a contact state between the zeolite serving as a carrier and the compound serving as the active substance cannot be controlled, and catalyst activity cannot be sufficiently improved.

Therefore, an object of the present disclosure is to implement a catalyst structure having a large specific surface area and high catalyst activity.

### SUMMARY

A catalyst structure according to an application example of the present disclosure is a catalyst structure which is for use in a reforming reaction for reforming a raw material and which has a particle shape, the catalyst structure including:
a core particle containing a first metal element and having a particle shape;
a coating film containing a second metal element and covering a surface of the core particle; and
a plurality of oxide particles each containing an oxide of the first metal element and adhering to a surface of the coating film, in which
both the coating film and the oxide particles are exposed.

A method for producing a catalyst structure according to an application example of the present disclosure is a method for producing the catalyst structure according to the application example of the present disclosure, the method including:
a preparation step of preparing the core particle; and
a film formation step of forming the coating film on a surface of the core particle by an atomic layer deposition method and depositing the oxide of the first metal element contained in the core particle on the surface of the coating film to form the oxide particle.

### BRIEF DESCRIPTION OF THE DRAWINGS

FIG. 1 is a cross-sectional view illustrating a catalyst structure according to an embodiment.

FIG. 2 is a graph illustrating an example of transition of an ion detection value corresponding to an amount of methanol generated when a reforming reaction for generating methanol from carbon dioxide and hydrogen is performed using two types of catalyst structures including coating films with different average thicknesses.

FIG. 3 is a process diagram illustrating a method for producing the catalyst structure illustrated in FIG. 1.

FIG. 4 is a cross-sectional view illustrating the method for producing the catalyst structure illustrated in FIG. 3.

FIG. 5 is a cross-sectional view illustrating the method for producing the catalyst structure illustrated in FIG. 3.

FIG. 6 is a cross-sectional view illustrating the method for producing the catalyst structure illustrated in FIG. 3.

FIG. 7 is a diagram illustrating a scanning transmission electron microscope image of the catalyst structure according to the embodiment and an element mapping analysis result by energy dispersive X-ray spectroscopy (EDS).

### DESCRIPTION OF EMBODIMENTS

Hereinafter, a catalyst structure and a method for producing a catalyst structure according to the present disclosure will be described in detail based on preferred embodiments illustrated in the accompanying drawings.

### 1. Catalyst Structure

First, a catalyst structure according to an embodiment will be described.

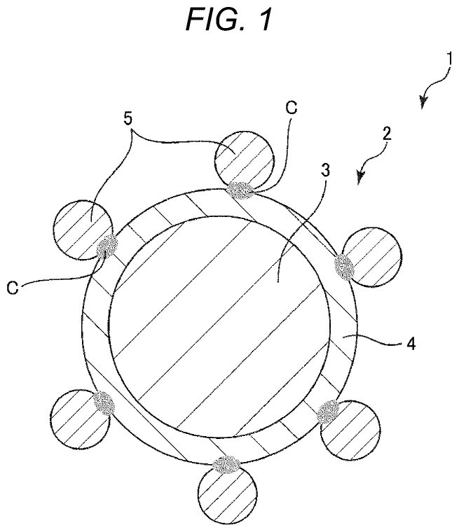

FIG. 1 is a cross-sectional view illustrating a catalyst structure 1 according to the embodiment.

The catalyst structure 1 illustrated in FIG. 1 is used as a catalyst in a reforming reaction for reforming a raw material. Examples of the raw material include, but are not limited to, carbon oxides such as carbon monoxide and carbon dioxide, hydrocarbons such as methane and propane, hydrogen, and water. When these raw materials come into contact with the catalyst structure 1, the raw materials are reformed to obtain a product. Examples of the product include, but are not limited to, hydrocarbons such as methane and propane and alcohols such as methanol and ethanol, in addition to hydrogen.

In the following description, for convenience of description, a case where carbon dioxide and hydrogen are used as the raw materials and the product is methanol will be described as an example.

### 1.1. Catalyst Particles

The catalyst structure 1 illustrated in FIG. 1 contains a plurality of catalyst particles 2 (aggregates of the catalyst particles 2).

The catalyst particle 2 includes a core particle 3, a coating film 4, and a plurality of oxide particles 5.

The core particle 3 contains a first metal element and has a particle shape. The coating film 4 contains a second metal element and covers a surface of the core particle 3. The oxide particle 5 contains an oxide of the first metal element and adheres to the surface of the coating film 4. In the catalyst particle 2, both the coating film 4 and the oxide particle 5 are exposed.

One of the first metal element and the second metal element is an element constituting a catalyst component, and the other is an element constituting a carrier component. These elements are present in a state of a simple substance, a mixture obtained by mixing with other elements, or a compound (such as an oxide) with other elements. Therefore, when the core particle 3 and the coating film 4 come into contact with each other, the coating film 4 containing the second metal element can be thinly distributed along the surface of the core particle 3. The coating film 4 thinly distributed in this way is considered to form a catalyst active point C at an interface with the oxide particle 5 to be described later. Since the catalyst active point C is formed for each catalyst particle 2, a large number of catalyst active points C are distributed at predetermined intervals in the entire catalyst structure 1. In the catalyst structure 1 according to the embodiment, a large number of catalyst active points C are considered to be formed being separated from each other at interfaces when the coating film 4 and the plurality of oxide particles 5 come into contact with each other. In this way, the plurality of catalyst active points C are formed in one catalyst particle 2. As a result, in the catalyst structure 1, contact efficiency between the raw material and the catalyst active point C is high, and an efficiency of the reforming reaction of the raw material can be improved.

Gaps are naturally formed between the catalyst particles 2. Therefore, exchange efficiency of the raw material is increased. The catalyst structure 1 containing the aggregate of the catalyst particles 2 has a large specific surface area. Therefore, more opportunities for contact between the raw material and the catalyst active point C can be ensured, and also from this viewpoint, the efficiency of the reforming reaction of the raw material can be increased.

The catalyst structure 1 has high fluidity by taking advantage of a shape of the catalyst particle 2. Therefore, it is easy to fill into containers or the like and easy to handle. Therefore, it is possible to inexpensively construct a reforming device in which the catalyst active points C are densely integrated. By using such a reforming device, a large amount of raw materials can be efficiently reformed even in a space-saving manner, and for example, a large amount of products such as methanol can be efficiently produced at low cost. In particular, when carbon dioxide is used as the raw material, carbon neutral and carbon negative can be implemented.

In the following description, an example in which the coating film 4 contains the carrier component and the oxide particle 5 contains the catalyst component will be described.

### 1.2. Core Particle

The core particle 3 contains the first metal element. The core particle 3 functions as a base material that supports the coating film 4. The core particle 3 also functions as a supply source for supplying the first metal element when the oxide particle 5 to be described later is formed. That is, when the core particle 3 contains the first metal element, a structure of the catalyst particle 2 to which the plurality of fine oxide particles 5 adheres can be implemented. The core particle 3 itself may function as the catalyst component.

Examples of the first metal element include Cu, Pt, In, Zn, Ru, Sn, Au, and Re. Among these elements, the first metal element is preferably Cu, Pt, or In, and more preferably Cu. These elements are present as a simple substance, a mixture, or a compound, and come into contact with the second metal element, exhibiting particularly high catalyst activity at the catalyst active point C. When various conditions (temperature, pressure, supply rate of raw material, reaction time, and the like) are adjusted and carbon dioxide and hydrogen are brought into contact with the catalyst active point C, for example, the probability of carbon dioxide being hydrogenated increases, and the efficiency of various reforming reactions such as generation of methanol is increased. Examples of the various conditions include a temperature of 300° C. or higher, a pressure of 1 MPa or more and 10 MPa or less, a supply rate of a gas containing the raw material of 100 mL/min or more, and the reaction time of 5 hours or longer and 8 hours or shorter.

The core particle 3 may contain an element other than the first metal element as necessary. Examples of the other element include at least one selected from the above first metal element, in addition to a non-metal element such as oxygen. When the other element is oxygen, a compound of the first metal element is an oxide. That is, the core particle 3 may contain a copper oxide, a platinum oxide, or an indium oxide. When the other element is the first metal element, the core particle 3 may contain an alloy of two or more kinds of first metal elements or an intermetallic compound.

As illustrated in FIG. 1, the core particle 3 has a particle shape. Specific examples of the shape of the core particle 3 include a polyhedron, a cylinder, a prism, a cone, a pyramid, a rod shape, and a needle shape in addition to a spherical shape such as a true sphere, an oval sphere, and an elliptical sphere, but other unspecified irregular shapes may be used. These shapes may be mixed.

An average aspect ratio of the core particle 3 is not particularly limited, but is preferably 1.0 or more and 5.0 or less, more preferably 1.0 or more and 3.0 or less, and further preferably 1.0 or more and 2.0 or less. When the average aspect ratio of the core particles 3 is within the above ranges, the catalyst structure 1 having excellent fluidity and filling properties is obtained. By using such a catalyst structure 1, it is possible to construct a reforming device in which the catalyst active points C are contained at a high density.

The average aspect ratio of the core particles 3 is calculated as follows. First, a projection image of the core particle 3 is captured by an electron microscope or an optical microscope. At this time, an imaging magnification is set such that the 50 to 100 core particles 3 appear in one image. Next, the obtained image is read into image processing software. Then, 50 or more particle images are detected by image processing, and an aspect ratio is calculated. Then, an average value of the calculated aspect ratios is referred to as an “average aspect ratio”. When a maximum length of the particle image is defined as a major axis and a maximum length in a direction orthogonal to an extending direction of the major axis is defined as a minor axis, the aspect ratio is determined by the major axis/the minor axis.

An average particle diameter of the core particles 3 is not particularly limited, but is preferably 5 μm or more and 100 μm or less, more preferably 10 μm or more and 80 μm or less, and further preferably 20 μm or more and 60 μm or less. When the average particle diameter of the core particles 3 is within the above ranges, the catalyst structure 1 having a sufficiently large specific surface area and excellent fluidity and filling properties is obtained. Accordingly, it is possible to implement a reforming device in which the catalyst active points C are contained at a high density.

When the average particle diameter of the core particle 3 is less than the above lower limit value, the degree of difficulty in producing the core particle 3 may be increased, aggregation is likely to occur, secondary particles of the catalyst structure 1 may be formed, and fluidity and filling properties may be reduced. In contrast, when the average particle diameter of the core particle 3 exceeds the above upper limit value, the specific surface area of the catalyst structure 1 may be reduced.

The average particle diameter of the core particle 3 is an average value of particle diameters (equivalent circle diameters) measured with 10 or more particle images randomly extracted after identifying the particle images of the core particle 3 based on a difference in contrast in the magnified observation image of the surface of the catalyst structure 1.

### 1.3. Coating Film

The coating film 4 covers the surface of the core particle 3. The coating film 4 preferably covers the entire surface of the core particle 3, but may have a non-coating portion.

The coating film 4 contains the second metal element, and functions as, for example, the carrier component on which the catalyst component is supported. Examples of the second metal element include Zr, Hf, Ta, Zn, Mo, Ti, Ga, Al, Sn, Al, and Ru. Among these elements, the second metal element is preferably Zr, Hf, Ta, Zn, Mo, Ti, Al, or Ru, and more preferably Zr. These elements come into contact with the first metal element, exhibiting particularly high catalyst activity at the catalyst active point C. When various conditions (temperature, pressure, supply rate of raw material, reaction time, and the like) are adjusted and carbon dioxide and hydrogen are brought into contact with the catalyst active point C, for example, the probability of carbon dioxide being hydrogenated increases, and the efficiency of various reforming reactions such as generation of methanol is increased. Examples of the various conditions include a temperature of 300° C. or higher, a pressure of 1 MPa or more and 10 MPa or less, a supply rate of a gas containing the raw material of 100 mL/min or more, and the reaction time of 5 hours or longer and 8 hours or shorter.

The coating film 4 may contain an element other than the second metal element as necessary. Examples of the other element include at least one selected from the above first metal element, in addition to a non-metal element such as oxygen. When the other element is oxygen, a compound of the second metal element is an oxide. That is, the coating film 4 may contain zirconium oxide, hafnium oxide, tantalum oxide, zinc oxide, molybdenum oxide, titanium oxide, aluminum oxide, or ruthenium oxide. When the coating film 4 contains an oxide of the second metal element, it is possible to implement the catalyst structure 1 having a particularly high catalyst activity. When the other element is the second metal element, the coating film 4 may contain an alloy of two or more kinds of second metal elements or an intermetallic compound.

Examples of a preferable combination of the first metal element contained in the core particle 3 and the oxide particle 5 to be described later and the second metal element contained in the coating film 4 include the following combinations.

When the first metal element is Cu, the second metal element is Zr, Hf, Ta, or Zn.
When the first metal element is Pt, the second metal element is Mo or Ti.
When the first metal element is In, the second metal element is Zr.

According to such combinations, the catalyst activity of the catalyst active point C can be particularly increased.

An average thickness of the coating film 4 is not particularly limited, but is preferably 0.1 nm or more and 5 nm or less, more preferably 0.3 nm or more and 3 nm or less, and further preferably 0.5 nm or more and 2 nm or less. When the average thickness of the coating film 4 is within the above ranges, the catalyst activity of the catalyst active point C is particularly increased, and the efficiency of the reforming reaction is particularly increased. One of reasons why such effects can be obtained is that when electrons and holes are exchanged between the coating film 4 and the oxide particle 5, the movement efficiency increases. In addition, as another reason, when the average thickness of the coating film 4 is within the above ranges, the core particle 3 and the oxide particle 5 are extremely close to each other via the coating film 4 containing the second metal element, thereby further increasing the movement efficiency of electrons and holes.

When the average thickness of the coating film 4 is less than the above lower limit value, the thickness of the coating film 4 may be insufficient and the efficiency of the reforming reaction may decrease, or the coverage of the coating film 4 may not be sufficiently increased. In contrast, when the average thickness of the coating film 4 exceeds the above upper limit value, the thickness of the coating film 4 may be excessive, and the efficiency of the reforming reaction may rather deteriorate.

The average thickness of the coating film 4 is obtained by acquiring enlarged observation images of cross sections of the five or more catalyst particles 2 using, for example, a scanning transmission electron microscope (STEM), measuring the thickness of each of the coating films 4 at five or more locations, and averaging the obtained measured values.

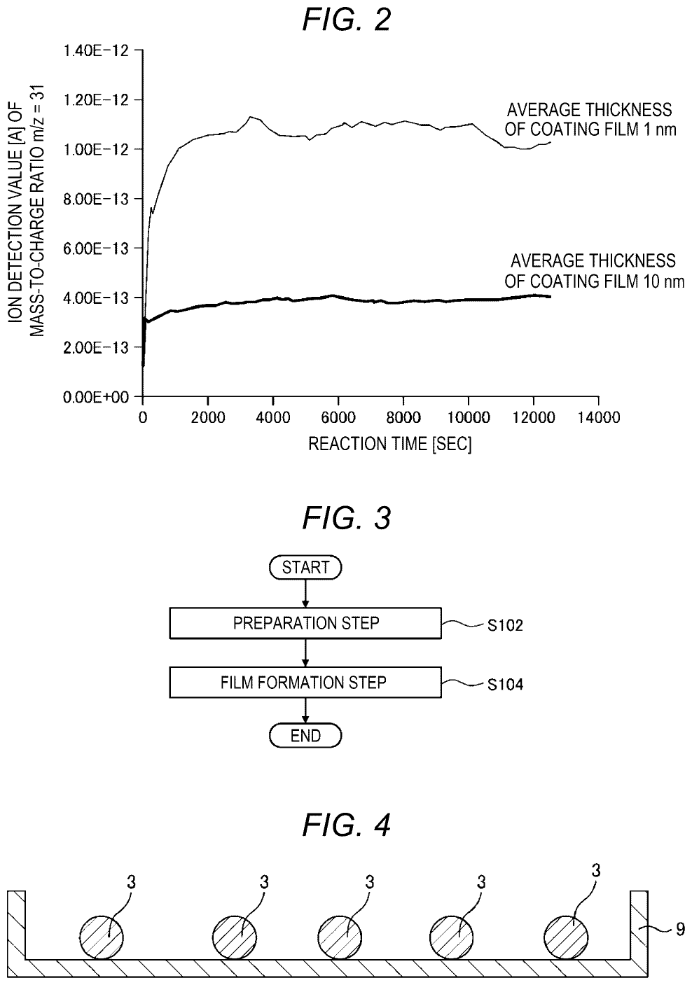

FIG. 2 is a graph illustrating an example of transition of an ion detection value corresponding to an amount of methanol generated when a reforming reaction for generating methanol from carbon dioxide and hydrogen is performed using two types of catalyst structures including the coating films 4 with different average thicknesses. A horizontal axis of FIG. 2 represents the reaction time [sec] of the reforming reaction, and a vertical axis represents the ion detection value [A] of the mass-to-charge ratio m/z=31.

In FIG. 2, the transition of the ion detection amount is compared between a catalyst structure in which the average thickness of the coating film 4 is 1 nm and a catalyst structure in which the average thickness of the coating film 4 is 10 nm. The ion detection value represents an amount of ions contained in gas when mixed gas containing carbon dioxide and hydrogen is brought into contact with the catalyst structure and then passes through a mass spectrometer. FIG. 2 illustrates the transition of the ion detection value of the mass-to-charge ratio m/z=31 derived from methanol.

As illustrated in FIG. 2, when the average thickness of the coating film 4 is within the above range, the ion detection value is higher than when the average thickness of the coating film 4 is out of the above range. Therefore, as illustrated in FIG. 2, the efficiency of the reforming reaction of the raw material is improved by optimizing the average thickness of the coating film 4 within the above range.

### 1.4. Oxide Particles

The plurality of oxide particles 5 each contains an oxide of the first metal element and adheres to the surface of the coating film 4. The oxide particle 5 adheres to only a part of the surface of the coating film 4, and other parts are exposed. That is, in the catalyst particle 2, both the coating film 4 and the oxide particle 5 are exposed.

The oxide particles 5 function as the catalyst component. Therefore, in the catalyst particle 2, the catalyst active point C is formed at the interface between the coating film 4 and the oxide particle 5. Since both the coating film 4 and the oxide particle 5 are exposed, the contact efficiency between the raw material such as carbon dioxide or hydrogen and the catalyst active point C increases. Accordingly, it is possible to implement the catalyst structure 1 having high efficiency of the reforming reaction of the raw material. In addition, since the plurality of oxide particles 5 adheres to one catalyst particle 2, the plurality of divided catalyst active points C is distributed on the surface of the coating film 4. Accordingly, the efficiency of the reforming reaction of the raw material by the catalyst structure 1 is further increased.

The exposure of both the coating film 4 and the oxide particle 5 can be evaluated by, for example, a surface elemental analysis such as X-ray photoelectron spectroscopy (XPS), ion scattering spectroscopy (ISS), or the like.

The oxide particle 5 particularly preferably contains copper oxide. The oxide particle 5 containing copper oxide forms the catalyst active point C exhibiting particularly high catalyst activity.

An average particle diameter of the oxide particles 5 is not particularly limited, but is preferably 0.5 nm or more and 100 nm or less, more preferably 1 nm or more and 50 nm or less, and further preferably 5 nm or more and 30 nm or less. When the average particle diameter of the oxide particles 5 is within the above ranges, the size necessary for the catalyst activity in the oxide particle 5 can be ensured, and the number density of the catalyst active points C each formed at the interface between the oxide particle 5 and the coating film 4 can be increased. Accordingly, the efficiency of the reforming reaction of the raw material by the catalyst structure 1 is particularly increased.

When the average particle diameter of the oxide particle 5 is less than the above lower limit value, it may become difficult to form the oxide particle 5. In contrast, when the average particle diameter of the oxide particle 5 exceeds the above upper limit value, the number density of the catalyst active points C decreases, and therefore the efficiency of the reforming reaction may decrease.

The average particle diameter of the oxide particle 5 is obtained by acquiring enlarged observation images of cross sections of the five or more catalyst particles 2 using, for example, a scanning transmission electron microscope (STEM), measuring a circle equivalent diameter of each of the five or more oxide particles 5, and averaging the obtained measured values.

When surface elemental analysis by the ion scattering spectroscopy (ISS) is performed on the catalyst structure 1, an abundance ratio of the second metal element to the first metal element is preferably 10/90 or more and 90/10 or less, more preferably 20/80 or more and 80/20 or less, and further preferably 30/70 or more and 70/30 or less in terms of atomic ratio. According to the ion scattering spectroscopy, an elemental analysis can be performed on the outermost surface of the catalyst structure 1. When the abundance ratio of the second metal element to the first metal element measured by such a method is within the above range, a balance between the first metal element and the second metal element exposed at the outermost surface of the catalyst structure 1 can be particularly optimized. That is, the balance of exposed areas of the coating film 4 and the oxide particle 5 can be optimized. Accordingly, the efficiency of the reforming reaction is particularly increased.

When the abundance ratio is less than the above lower limit value or exceeds the above upper limit value, the balance between the first metal element and the second metal element may deteriorate, and the efficiency of the reforming reaction may decrease.

### 2. Method for Producing Catalyst Structure

Next, a method for producing a catalyst structure according to the embodiment (a method for producing the catalyst structure 1 illustrated in FIG. 1) will be described.

FIG. 3 is a process diagram illustrating the method for producing the catalyst structure 1 illustrated in FIG. 1. FIGS. 4 to 6 are cross-sectional views illustrating the method for producing the catalyst structure 1 illustrated in FIG. 3. In the following description, an upper side in FIGS. 4 to 6 is referred to as “upper” and a lower side is referred to as “lower”.

The method for producing the catalyst structure 1 illustrated in FIG. 3 is a method for producing the catalyst structure 1 illustrated in FIG. 1, and includes a preparation step S102 and a film formation step S104. In the preparation step S102, the core particle 3 is prepared. In the film formation step S104, the coating film 4 is formed on the surface of the core particle 3 by the atomic layer deposition method, and the oxide of the first metal element contained in the core particle 3 is deposited on the surface of the coating film 4 to form the oxide particle 5. Accordingly, it is possible to easily produce the catalyst structure 1 having a large specific surface area and high catalyst activity.

### 2.1. Preparation Step

In the preparation step S102, the core particle 3 is prepared. As described above, the core particle 3 is a particle containing the first metal element, and examples thereof include a Cu particle. For example, as illustrated in FIG. 4, the core particles 3 are supplied to the next step in a state of being accommodated in a tray 9. A material forming the tray 9 is not particularly limited, but a metal material such as stainless steel is preferably used.

The preparation step S102 may include a surface treatment on the core particle 3. Examples of the surface treatment include an ozone treatment of bringing the core particle 3 into contact with ozone, a plasma treatment of bringing a plasma into contact with the core particle 3, a corona treatment of performing corona discharge on the core particle 3, and an ultraviolet treatment for irradiating the core particle 3 with ultraviolet rays. By performing such a surface treatment, the core particle 3 is cleaned, and the adhesion and chemical bonding properties between the core particle 3 and the coating film 4 are improved.

Among the above surface treatments, the ozone treatment is preferably used. According to the ozone treatment, organic substances and the like on the surface can be efficiently removed to clean the surface while minimizing damage to the core particle 3. A time of the ozone treatment is not particularly limited, but is preferably 1 minute or longer and 60 minutes or shorter, and more preferably 5 minutes or longer and 20 minutes or shorter.

### 2.2. Film Formation Step

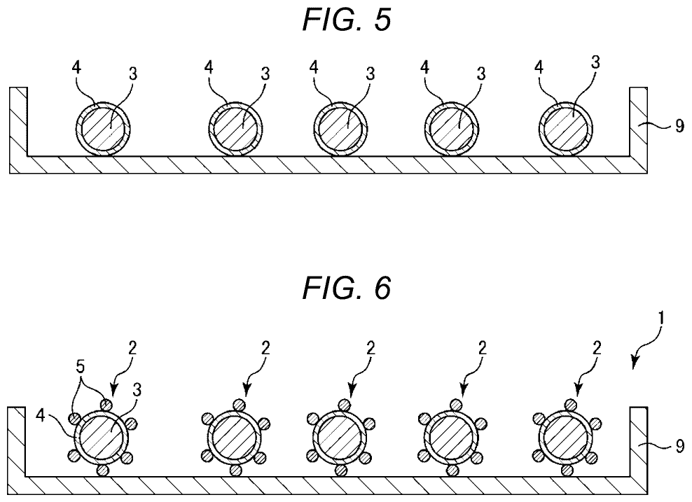

In the film formation step S104, as illustrated in FIG. 5, the coating film 4 is formed on the surface of the core particle 3. The oxide of the first metal element contained in the core particle 3 is deposited on the surface of the coating film 4. Accordingly, the oxide particles 5 are formed as illustrated in FIG. 6. The formation of the coating film 4 and the formation of the oxide particles 5 are considered to be performed alternately or substantially simultaneously. Specifically, first, in a process of forming the coating film 4, the first metal element contained in the core particle 3 floats. Next, a reactant of a coating film raw material gas containing the second metal element is deposited on the surface of the core particle 3 to form the coating film 4. After the coating film 4 is formed, the oxide of the first metal element is considered to be deposited on the surface of the coating film 4. As a result, the oxide particles 5 adhere to the surface of the coating film 4, and the catalyst particle 2 is obtained.

Examples of a method for forming the coating film 4 include a vacuum deposition method, a sputtering method, a CVD method, and an atomic layer deposition method (ALD). Among these methods, the atomic layer deposition method is preferably used. By forming the coating film 4 using the atomic layer deposition method, it is possible to efficiently form the coating film 4 having a small thickness and high coverage. Specifically, in the atomic layer deposition method, since a film formation amount can be controlled at an atomic layer level, the film thickness of the coating film 4 can be precisely controlled, thereby achieving both thinning and high coverage of the coating film 4.

In the atomic layer deposition method, since the coating film raw material gas or an oxidizing agent can reach even portions that are shaded from the supply source and form a film thereon, the coverage of the coating film 4 can be easily increased. According to the atomic layer deposition method, it is possible to produce the catalyst structure 1 in which a variation in the coverage of the coating film 4 is small for each catalyst particle 2.

The coating film raw material gas and the oxidizing agent used in the atomic layer deposition method are appropriately selected according to the material forming the coating film 4. For example, the coating film raw material gas is gas containing a precursor of the forming material. For example, when the second metal element contained in the coating film 4 is Zr, zirconium oxide (ZrO₂) can be used as the material forming the coating film 4. In this case, the precursor may be an inorganometallic compound such as a halide containing the second metal element, and an organometallic compound containing the second metal element is preferably used. Since vapor pressure of the coating film raw material gas can be easily increased by using the organometallic compound, the film thickness of the coating film 4 can be more precisely controlled. Examples of the organometallic compound include Zr (O^{t}Bu)₄ (zirconium tert-butoxide, (NEt₂)₄(tetrakis ZTB), Zr (diethylamide) zirconium, TDEAZ), Zr (NMeEt)₄(tetrakis (ethylmethylamide) zirconium, TEMAZ), and Zr (NMe₂)₄(tetrakis (dimethylamide) zirconium, TDMAZ).

Hereinafter, an example of a procedure for forming the coating film 4 with the atomic layer deposition method will be described. First, the tray 9 accommodating the core particles 3 is placed in a chamber capable of evacuation and atmosphere control. Next, a coating film raw material gas containing a precursor is introduced into the chamber to adsorb the precursor on the surface of the core particle 3. Next, after the excess coating film raw material gas is discharged, an oxidizing agent is introduced into the chamber. Examples of the oxidizing agent include ozone, plasma oxygen, and water vapor. The introduced oxidizing agent reacts with the precursor adsorbed to the core particle 3 to form the coating film 4. In this way, in the atomic layer deposition method, the formation of the coating film 4 and the formation of the oxide particle 5 adhering to the surface thereof can be sequentially performed by performing an operation of supplying, for example, the organometallic compound containing the second metal element as the precursor of the coating film 4 to the core particle 3 placed under reduced pressure. Accordingly, the catalyst particle 2 can be efficiently produced.

A temperature of the core particle 3 when forming the coating film 4 is appropriately set according to, for example, a type of the precursor or the oxidizing agent, and is preferably 100° C. or higher and 350° C. or lower, and more preferably 120° C. or higher and 200° C. or lower. Accordingly, it is possible to react the precursor with high accuracy while preventing deterioration of the core particle 3 due to heat. As a result, it is possible to form the coating film 4 having a sufficiently high content of a target forming material and capable of achieving a highly efficient reforming reaction.

In particular, when the temperature of the core particle 3 is 120° C. or higher and 200° C. or lower, it is considered that the surface of the core particle 3 can be appropriately vaporized to cause an appropriate amount of copper atoms to float. The floating copper atoms combine with the oxidizing agent and are oxidized to form an oxide of the first metal element. It is considered that the oxide of the first metal element deposits on the surface of the coating film 4 while agglomerating in a particle shape, or deposits on the surface of the coating film 4 and then agglomerates. Accordingly, a necessary and sufficient amount of oxide particles 5 is obtained.

Pressure in the chamber when forming the coating film 4 is preferably 100 Pa or less, more preferably 0.001 Pa or more and 10 Pa or less, and further preferably 0.001 Pa or more and 1 Pa or less. Accordingly, since the concentrations of the precursor and the oxidizing agent can be optimized, the reaction efficiency of the precursor can be increased. When the pressure in the chamber is within the above range, the copper atoms are easily desorbed from the surface of the core particle 3. Accordingly, it is possible to efficiently form the oxide particle 5 having a desired amount and size. As a result, it is possible to form the coating film 4 having a sufficiently high content of a target forming material and capable of achieving a highly efficient reforming reaction. Accordingly, the catalyst particle 2 is obtained.

An amount of the formed oxide particles 5 can be adjusted according to the amount of floating copper atoms. For example, the amount of the formed oxide particles 5 can be increased by, for example, increasing the temperature of the core particle 3, reducing the pressure in the chamber, and lengthening the formation time of the coating film 4 when forming the coating film 4. In contrast, when the reverse operation is performed, the amount of the formed oxide particles 5 can be reduced.

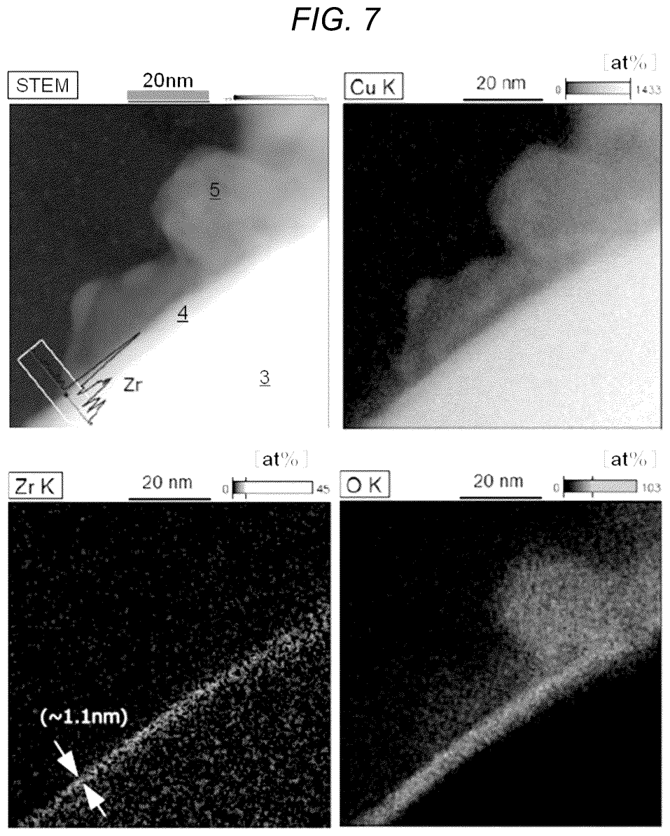

FIG. 7 is a diagram illustrating a scanning transmission electron microscope image of the catalyst structure according to the embodiment and an element mapping analysis result by energy dispersive X-ray spectroscopy (EDS). The first metal element contained in the catalyst structure illustrated in FIG. 7 is Cu, and the second metal element is Zr.

In the scanning transmission electron microscope STEM illustrated in FIG. 7, the core particle 3, a part of the coating film 4, and the oxide particle 5 adhering to the surface of the coating film 4 are represented by a light color. This image illustrates that both the coating film 4 and the oxide particle 5 are exposed. In this image, a line analysis result of the content of Zr is superimposed as a graph.

In a mapping image of a Cu-K line illustrated in FIG. 7, the light color spreads in regions corresponding to the core particle 3 and the oxide particle 5. This image illustrates that the core particle 3 and the oxide particle 5 contain Cu.

In a mapping image of a Zr-K line illustrated in FIG. 7, the light color spreads in a region corresponding to the coating film 4. This image illustrates that the coating film 4 contains Zr. The thickness of the coating film 4 can also be measured from the mapping image of the Zr-K line. This image illustrates that the thickness of the coating film 4 is about 1.1 nm. As can be seen from the graph superimposed on the scanning transmission electron microscope STEM, Zr is unevenly distributed in the coating film 4.

In a mapping image of an O-K line illustrated in FIG. 7, the light color spreads in regions corresponding to the coating film 4 and the oxide particle 5. This image illustrates that an oxide of Zr is contained in the coating film 4 and an oxide of Cu is contained in the oxide particle 5.

After the film formation step S104, a reduction treatment may be performed on the catalyst particle 2 as necessary. By performing the reduction treatment, the oxide is reduced in at least one of the coating film 4 and the oxide particle 5. Specifically, when the second metal element contained in the coating film 4 is in an oxide state, the second metal element can be changed to a metal by reduction. The oxide of the first metal element contained in the oxide particle 5 can also be changed to a metal by reduction. Accordingly, the catalyst activity at the catalyst active point C may be increased.

Examples of a reducing agent used in the reduction treatment include hydrogen, carbon monoxide, and methane. The catalyst particle 2 may be heated under reduced pressure, and the oxide may be reduced by thermal dissociation. Among these reducing agents, the reduction treatment using hydrogen is preferably used in consideration of the stability, efficiency, safety, and the like of the reduction reaction. Accordingly, the catalyst structure 1 having increased reforming efficiency is obtained.

When the reduction treatment using the reducing agent is performed, the catalyst particle 2 is heated while the reducing agent is introduced into a heating furnace.

A temperature in the heating furnace in the reduction treatment is not particularly limited, but is preferably 100° C. or higher and 700° C. or lower, and more preferably 200° C. or higher and 500° C. or lower. A heating time is not particularly limited, but is preferably 0.5 hours or longer and 10 hours or shorter, and more preferably 1 hour or longer and 5 hours or shorter. Accordingly, the catalyst activity at the catalyst active point C can be efficiently increased.

An amount of the reducing agent introduced into the heating furnace in the reduction treatment is not particularly limited, but is preferably 10 mL/min or more and 1000 mL/min or less, and more preferably 50 mL/min or more and 500 mL/min or less. By performing the adjustment to such optimum values, the catalyst activity at the catalyst active point C can be efficiently increased.

### 3. Effects of Embodiment

As described above, the catalyst structure 1 according to the embodiment is a catalyst structure that is used for a reforming reaction for reforming a raw material and has a particle shape, and contains the core particles 3, the coating film 4, and the plurality of oxide particles 5. The core particle 3 contains the first metal element and has a particle shape. The coating film 4 contains the second metal element and covers the surface of the core particle 3. The oxide particle 5 contains an oxide of the first metal element and adheres to the surface of the coating film 4. In the catalyst structure 1, both the coating film 4 and the oxide particle 5 are exposed.

According to such a configuration, it is possible to implement the catalyst structure 1 having a large specific surface area and high catalyst activity. The plurality of catalyst active points C is formed in one catalyst particle 2 contained in the catalyst structure 1. As a result, in the catalyst structure 1, contact efficiency between the raw material and the catalyst active point C is high, and an efficiency of the reforming reaction of the raw material can be improved. The catalyst structure 1 has high fluidity by taking advantage of a shape of the catalyst particle 2. Therefore, it is easy to fill into containers or the like and easy to handle.

In the catalyst structure 1 according to the embodiment, the average particle diameter of the core particles 3 is preferably 5 μm or more and 100 μm or less.

According to such a configuration, the catalyst structure 1 having a sufficiently large specific surface area and excellent fluidity and filling properties is obtained. Accordingly, it is possible to implement a reforming device in which the catalyst active points C are contained at a high density.

In the catalyst structure 1 according to the embodiment, the average thickness of the coating film 4 is preferably 0.1 nm or more and 5 nm or less.

According to such a configuration, the catalyst activity of the catalyst structure 1 is particularly increased, and the efficiency of the reforming reaction is particularly increased.

In the catalyst structure 1 according to the embodiment, the average particle diameter of the oxide particle 5 is preferably 0.5 nm or more and 100 nm or less.

According to such a configuration, the size necessary for the catalyst activity in the oxide particle 5 can be ensured, and the number density of the catalyst active points C each formed at the interface between the oxide particle 5 and the coating film 4 can be increased. Accordingly, the efficiency of the reforming reaction of the raw material by the catalyst structure 1 is particularly increased.

In the catalyst structure 1 according to the embodiment, the coating film 4 preferably contains an oxide of the second metal element.

According to such a configuration, it is possible to implement the catalyst structure 1 having particularly high catalyst activity.

In the catalyst structure 1 according to the embodiment, the first metal element is preferably Cu, Pt, or In, and the second metal element is preferably Zr, Hf, Ta, Zn, Mo, Ti, Al, or Ru.

According to such a configuration, it is possible to implement the catalyst structure 1 having particularly high catalyst activity.

The method for producing a catalyst structure according to the embodiment is a method for producing the catalyst structure 1 according to the embodiment, and includes the preparation step S102 and the film formation step S104.

In the preparation step S102, the core particle 3 is prepared. In the film formation step S104, the coating film 4 is formed on the surface of the core particle 3 by an atomic layer deposition method, and the oxide of the first metal element contained in the core particle 3 is deposited on the surface of the coating film 4 to form the oxide particle 5.

According to such a configuration, it is possible to easily produce the catalyst structure 1 having a large specific surface area and high catalyst activity.

In the method for producing a catalyst structure according to the embodiment, the preparation step S102 may include an ozone treatment of bringing the core particle 3 into contact with ozone.

According to such a configuration, organic substances and the like on the surface can be efficiently removed to clean the surface while minimizing damage to the core particle 3.

In the method for producing a catalyst structure according to the embodiment, when the coating film 4 is formed in the film formation step S104, the temperature of the core particle 3 is preferably 120° C. or higher and 200° C. or lower.

According to such a configuration, it is considered that the surface of the core particle 3 can be appropriately vaporized to cause an appropriate amount of copper atoms to float. The floating copper atoms combine with the oxidizing agent and are oxidized to form an oxide of the first metal element. It is considered that the oxide of the first metal element deposits on the surface of the coating film 4 while agglomerating in a particle shape, or deposits on the surface of the coating film 4 and then agglomerates. Accordingly, a necessary and sufficient amount of oxide particles 5 is obtained.

In the method for producing a catalyst structure according to the embodiment, the atomic layer deposition method may include an operation of supplying an organometallic compound containing the second metal element as the precursor of the coating film 4 to the core particle 3 placed under reduced pressure.

According to such a configuration, the formation of the coating film 4 and the formation of the oxide particle 5 adhering to the surface thereof can be sequentially performed. Accordingly, the catalyst structure 1 can be efficiently produced.

Although the catalyst structure and the method for producing a catalyst structure according to the present disclosure have been described based on a preferred embodiment, the present disclosure is not limited thereto. For example, the catalyst structure according to the present disclosure may be what is obtained by replacing each unit of the embodiment described above with any component having a similar function, or what is obtained by adding any constituent to the embodiment described above.

The method for producing a catalyst structure according to the present disclosure may include any step added for any purpose to the above embodiment.

What is claimed is:

1. A catalyst structure, which is for use in a reforming reaction for reforming a raw material and which has a particle shape, the catalyst structure comprising:
a core particle containing a first metal element and having a particle shape;
a coating film containing a second metal element and covering a surface of the core particle; and
a plurality of oxide particles each containing an oxide of the first metal element and adhering to a surface of the coating film, wherein
both the coating film and the oxide particles are exposed.

2. The catalyst structure according to claim 1, wherein
an average particle diameter of the core particle is 5 μm or more and 100 μm or less.

3. The catalyst structure according to claim 2, wherein
an average thickness of the coating film is 0.1 nm or more and 5 nm or less.

4. The catalyst structure according to claim 2, wherein
an average particle diameter of the oxide particle is 0.5 nm or more and 100 nm or less.

5. The catalyst structure according to claim 1, wherein
the coating film contains an oxide of the second metal element.

6. The catalyst structure according to claim 1, wherein
the first metal element is Cu, Pt, or In, and
the second metal element is Zr, Hf, Ta, Zn, Mo, Ti, Al, or Ru.

7. A method for producing a catalyst structure, which is a method for producing the catalyst structure according to claim 1, the method comprising:
a preparation step of preparing the core particle; and
a film formation step of forming the coating film on a surface of the core particle by an atomic layer deposition method and depositing the oxide of the first metal element contained in the core particle on the surface of the coating film to form the oxide particle.

8. The method for producing a catalyst structure according to claim 7, wherein
the preparation step includes an ozone treatment of bringing the core particle into contact with ozone.

9. The method for producing a catalyst structure according to claim 7, wherein
when forming the coating film in the film formation step, a temperature of the core particle is 120° C. or higher and 200° C. or lower.

10. The method for producing a catalyst structure according to claim 7, wherein
the atomic layer deposition method includes an operation of supplying an organometallic compound containing the second metal element as a precursor of the coating film to the core particle placed under reduced pressure.
